(19) United States
(12) Patent Application Publication
(10) Pub. No.: US 2023/0083818 A1
(43) Pub. Date: Mar. 16, 2023

(54) JUDGMENT SUPPORT APPARATUS, JUDGMENT SUPPORT METHOD, AND COMPUTER-READABLE RECORDING MEDIUM

(71) Applicant: NEC Corporation, Minato-ku, Tokyo (JP)

(72) Inventors: Shigenori BEPPU, Tokyo (JP); Keita SUZUKI, Tokyo (JP); Shigeki SHINODA, Tokyo (JP); Norifumi YAMAZAKI, Tokyo (JP); Hiroki NAOSHIMA, Tokyo (JP); Daisuke IKEFUJI, Tokyo (JP); Daisuke YAMAKAWA, Tokyo (JP); Mikiko MAKISE, Tokyo (JP)

(73) Assignee: NEC Corporation, Minato-ku, Tokyo (JP)

(21) Appl. No.: 17/801,071

(22) PCT Filed: Mar. 24, 2020
(86) PCT No.: PCT/JP2020/012936

§ 371 Date: Aug. 19, 2022

(51) Int. Cl. G06Q 50/26; G06V 10/22; G06V 20/50

(52) U.S. Cl. CPC G06Q 50/26; G06V 10/22; G06V 20/50

(57) ABSTRACT

There is provided a judgment support apparatus 100 including: a disaster situation estimating unit 110 configured to estimate a disaster situation in an object region from disaster related information using a disaster situation estimation model; and a determining unit 120 configured to determine, based on at least an estimated disaster situation and a presentation destination of judgment support information for supporting judgment with respect to the disaster situation, the judgment support information to be presented to the presentation destination.

### TECHNICAL FIELD

The present invention relates to a judgment support apparatus and a service provision method in which the judgment support apparatus is used, and also to a computer readable recording medium having recorded thereon a program for realizing the apparatus and method.

### BACKGROUND ART

When a disaster occurs, a local government, a firefighting organization, and ordinary citizens each need to make appropriate decisions and act appropriately. A system for supporting disaster response is proposed in order to quickly and appropriately perform judgment and handling when a disaster occurs.

For example, in Patent Document 1, with respect to a landslide caused by rainfall, a landslide disaster crisis management system is disclosed for mediating information exchange between administrative authorities and residents using a computer and a network. In this system, landslide disaster related information, a prediction result of the predicted landslide disaster occurrence risk, and geographical information are combined, landslide disaster occurrence risk information at various points is allocated on a map, and this map is transmitted to residents and related administrative agencies. Accordingly, in a situation in which a landslide disaster is predicted, the related administrative agencies collect and manage obtained information in an integrated manner and the information can be accessed by administrative agencies and residents in real time, and as a result, quick and appropriate administrative response is realized with respect to the landslide disaster.

Also, for example, in Patent Document 2, a disaster prevention project support system is disclosed in which a predictive quantity of a variant physical quantity is calculated, for support, using the variant physical quantity and an induced physical quantity, from a changing situation, while automatically learning past histories, and the predictive quantity is displayed, and additional learning is easily performed in a short time. In this system, changes in a situation can be followed, and a high generalization ability can be maintained.

### LIST OF RELATED ART DOCUMENTS

### Patent Document

Patent Document 1: JP2003-247238A

Patent Document 2: JP2005-301840A

### SUMMARY OF INVENTION

### Problems to be Solved by the Invention

Here, how the information provided at the time of a disaster is understood differs between users such as a local government, a firefighting organization, and ordinary citizens. For example, when a situation in which a road is blocked by a fallen tree is envisioned, there may be a case where ordinary citizens need to notified of the fact “road closed”, which is road hazard information, but it is desirable that a firefighting organization is notified of the fact “road can be opened by cutting tree”. However, in known systems such as those disclosed in Patent Documents 1 and 2, the users of the system are not taken into consideration when information is provided at the time of a disaster.

An exemplary object of the present invention is to provide a judgment support apparatus, a judgment support method, and a computer readable recording medium, with which judgment by a user with respect to a disaster situation can be supported in accordance with the user who is provided with information at the time of a disaster.

### Means for Solving the Problems

In order to achieve the aforementioned object, there is provided a judgment support apparatus including:

a disaster situation estimating unit configured to estimate a disaster situation in an object region from disaster related information using a disaster situation estimation model; and

a determining unit configured to determine, based on at least an estimated disaster situation and a presentation destination of judgment support information for supporting judgment with respect to the disaster situation, the judgment support information to be presented to the presentation destination.

Also, in order to achieve the aforementioned object, there is provided a judgment support method including:

estimating a disaster situation in an object region from disaster related information using a disaster situation estimation model; and

determining, based on at least an estimated disaster situation and a presentation destination of judgment support information for supporting judgment with respect to the disaster situation, the judgment support information to be presented to the presentation destination.

Also, in order to achieve the aforementioned object, there is provided a computer readable recording medium that includes a program recorded thereon, the program causing a computer to function as a judgment support apparatus including:

a disaster situation estimating unit configured to estimate a disaster situation in an object region from disaster related information using a disaster situation estimation model; and

a determining unit configured to determine, based on at least an estimated disaster situation and a presentation destination of judgment support information for supporting judgment with respect to the disaster situation, the judgment support information to be presented to the presentation destination.

### Advantageous Effects of the Invention

As described above, according to the present invention, it can be supported with which judgment by a user with respect to a disaster situation in accordance with the user who is provided with information at the time of a disaster.

### BRIEF DESCRIPTION OF THE DRAWINGS

FIG. 1 is a block diagram illustrating one exemplary configuration of the judgment support apparatus according to one embodiment of the present invention.

FIG. 2 is a diagram for describing an outline of processing to be performed by the judgment support apparatus according to the present example embodiment.

FIG. 3 is a block diagram illustrating one exemplary configuration of the judgment support apparatus according to the present example embodiment.

FIG. 4 is a flowchart illustrating an example of the judgment support method according to the present example embodiment.

FIG. 5 is one exemplary presentation of the judgment support information.

FIG. 6 describes an exemplary presentation of the judgment support information when the user attributes of the presentation destinations are different.

FIG. 7 describes an exemplary presentation of the judgment support information when the properties of the presentation destinations are different, although the user attributes thereof are the same.

FIG. 8 is a block diagram illustrating one example of a computer that realizes the judgment support apparatus according to the example embodiment.

### EXAMPLE EMBODIMENT

[1. Outline]

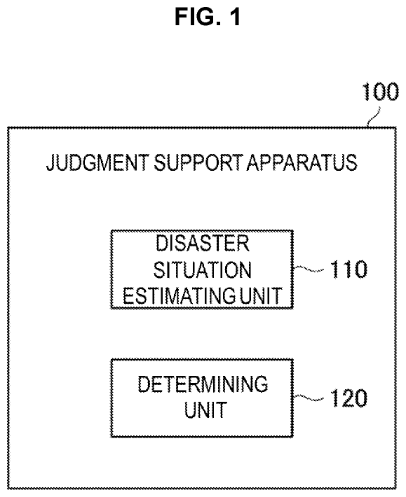

First, the configuration and functions of a judgment support apparatus 100 according to one embodiment of the present invention will be described based on FIG. 1. FIG. 1 is a block diagram illustrating one exemplary configuration of the judgment support apparatus 100 according to the present example embodiment.

The judgment support apparatus 100 according to the present example embodiment is an apparatus that supports the assessment of the situation by a user at the time of a disaster. When a disaster occurs, the user assesses the disaster situation and makes a decision based on a large amount of, spatially and temporally, disaster related information such as weather information, geographical information, people flow information, and hazard information. Here, how the information provided at the time of a disaster is understood differs according to user attributes of users such as a local government, firefighting organization, and ordinary citizens. The judgment support apparatus 100 according to the present example embodiment supports the user to assess the situation at the time of a disaster by determining the judgment support information to be presented based on the disaster situation and the presentation destination of the judgment support information for supporting judgment regarding the disaster situation.

Specifically, as shown in FIG. 1, the judgment support apparatus 100 includes a disaster situation estimating unit 110 and a determining unit 120. The disaster situation estimating unit 110 at least estimates the disaster situation in an object region using a disaster situation estimation model, based on disaster related information. The determining unit 120 determines the judgment support information to be presented to a presentation destination based on the disaster situation estimated by the disaster situation estimating unit 110 and the presentation destination of the judgment support information.

Users whose user attributes are different, such as a local government, a firefighting organization, and ordinary citizens are envisioned as the presentation destinations of the judgment support information, for example. Alternatively, local governments, although the user attributes are the same, whose local government properties such as a geological property and a social property, for example, are different are considered to be different presentation destinations. In this case, the judgment support apparatus 100 presents judgment support information corresponding to each local government.

Accordingly, the judgment support apparatus 100 can present appropriate judgment support information according to the presentation destination of the judgment support information. As a result, appropriate judgment support information can be presented to each of the users whose viewpoints regarding the same disaster situation are different. As a result, the users can make disaster response appropriately and smoothly.

[2. Apparatus Configuration]

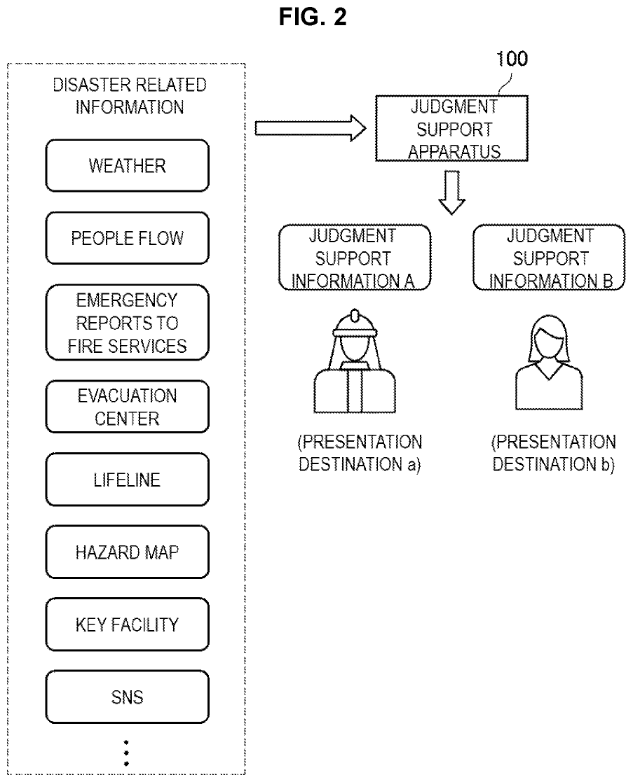

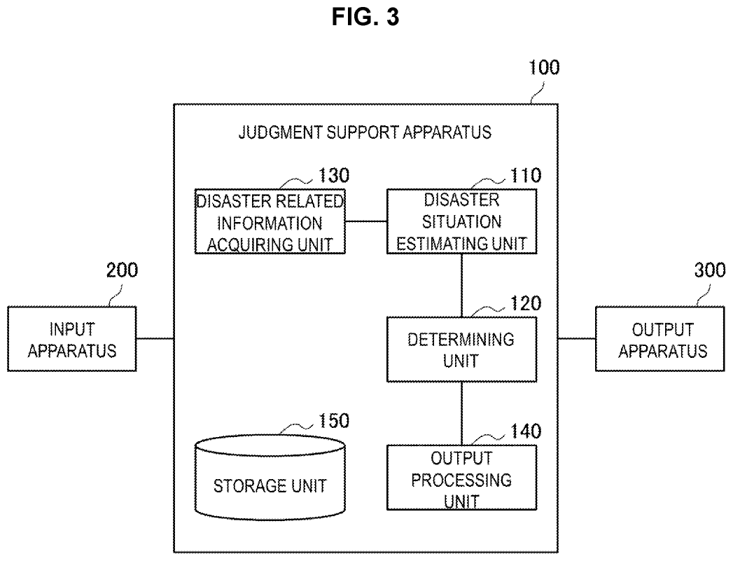

The configuration and functions of the judgment support apparatus 100 according to the present example embodiment will be described based on FIGS. 2 and 3. FIG. 2 is a diagram for describing an outline of processing to be performed by the judgment support apparatus 100 according to the present example embodiment. FIG. 3 is a block diagram illustrating one exemplary configuration of the judgment support apparatus 100 according to the present example embodiment.

As shown in FIG. 2, the judgment support apparatus 100 according to the present example embodiment estimates the disaster situation in an object region by analyzing disaster related information, and presents judgment support information according to a presentation destination based on the estimated disaster situation and the presentation destination of the judgment support information. The disaster related information includes weather information, people flow information, information regarding emergency reports to fire services, evacuation center information, lifeline information, a hazard map, key facility information, and disaster related SNS (social networking service), for example.

The weather information includes rainfall amount information, raincloud information, snow fall information, wind speed information, and temperature information, for example. The people flow information is information representing people flow that changes moment by moment, and is represented by flow lines of people, for example. The information regarding emergency reports to fire services includes information regarding the number of emergency reports and a dispatch history of a firefighting organization in response to the reports, for example. The evacuation center information includes information regarding the location, capacity, and number of currently accommodated persons in an evacuation center, for example. The lifeline information is information regarding the disaster damage to infrastructure equipment for electricity, water supply, gas, and communications, and the like. The hazard map is information in which information regarding risks such as a flood disaster, a landslide disaster, and tsunami and road disaster prevention information are shown in association with geographical information. The key facility information is information regarding facilities that are important organizations when affected by a disaster, such as a hospital. The disaster related SNS includes the number of submissions of SNS messages submitted when a disaster occurs, posted pictures, and the like.

The disaster related information may be acquired as time series data, for each area, for example. The time series data may be temporally continuous or discontinuous. Note that the judgment support apparatus 100 may also use topographical information such as altitude for analysis, in addition to the disaster related information, for example.

The judgment support apparatus 100 presents, from a disaster situation estimated based on the disaster related information using a disaster situation estimation model, judgment support information according to a presentation destination corresponding to the disaster situation, to the presentation destination. For example, regarding the estimated disaster situation, the judgment support apparatus 100 presents judgment support information A to a presentation destination a (e.g., firefighting organization), and presents judgment support information B to a presentation destination b (e.g., ordinary citizens). In this way, appropriate judgment support information can be presented to each of presentation destinations that differs in viewpoint regarding the same disaster situation.

The configuration of the judgment support apparatus 100 according to the present example embodiment will be described in more detail. As shown in FIG. 3, the judgment support apparatus 100 includes the disaster situation estimating unit 110, the determining unit 120, a disaster related information acquiring unit 130, an output processing unit 140, and a storage unit 150.

As described in FIG. 1, the disaster situation estimating unit 110 estimates the disaster situation in an object region from disaster related information using a disaster situation estimation model. Upon receiving input of disaster related information from the later-described disaster related information acquiring unit 130, the disaster situation estimating unit 110 analyzes the disaster related information, and estimates the disaster situation in the object region. The disaster situation estimating unit 110 estimates the disaster situation using a disaster situation estimation model that is generated, in advance, by performing machine learning using disaster related information acquired at the time of disaster that has occurred in the past.

The disaster situation estimation model may also be generated using machine learning such as a decision tree and multivariable analysis, for example. Note that it is desirable that an algorithm with which the analysis result is explicable is applied to the machine learning. Specifically, upon the disaster related information such as “150 people have evacuated to X elementary school”, “cracks formed in mountain Y behind X elementary school”, or “rain is expected within one hour” being input to the disaster situation estimation model, for example, the disaster situation estimating unit 110 outputs information such as “X elementary school (evacuation center) may be affected by disaster” as a disaster situation.

Also, the above-described disaster related information is used to construct the disaster situation estimation model to be used in the judgment support apparatus 100 according to the present example embodiment, and as a result of people flow information being included as disaster related information, the disaster damage situation can be more accurately analyzed. For example, when there is a flow of many people departing from a certain region, it is conceivable that a large disaster has occurred in the region from which people are leaving. Also, when very few people are moving from a region in which it is highly possible that a disaster has occurred, which is estimated based on weather information and a hazard map, for example, it is conceivable that roads are blocked and that people are isolated. In this way, as a result of constructing the disaster situation estimation model while considering the people flow information, the judgment support apparatus 100 can more accurately estimate the disaster damage situation. The disaster situation estimating unit 110 outputs the result of estimating the disaster situation of the object region to the determining unit 120.

As described in FIG. 1, the determining unit 120 determines the judgment support information to be presented to a presentation destination based on at least the disaster situation estimated by the disaster situation estimating unit 110 and the presentation destination of the judgment support information. The determining unit 120 acquires the presentation destination of the judgment support information. The presentation destination can be specified based on a user ID that has been set for each presentation destination when the user first started using the judgment support apparatus 100, for example.

Upon acquiring the presentation destination, the determining unit 120 determines the judgment support information to be presented based on the estimated disaster situation and the acquired presentation destination. The determining unit 120 may determine the judgment support information to be presented by referring to a presentation information table that shows the correspondence relationship between presentation destinations that have been acquired in advance and pieces of judgment support information, for example. The presentation information table is information in which, for each presentation destination, judgments with respect to disaster situations are collected, based on replies obtained in response to questions or the like asked to the presentation destinations, in advance. The presentation information table is recorded in the later-described storage unit 150, for example.

Alternatively, the determining unit 120 may also determine the judgment support information to be presented using a presentation information determination model for determining the judgment support information to be presented. The presentation information determination model may be generated by performing machine learning in which estimated disaster situations or disaster related information are pieces of input information, and judgments with respect to disaster situations, which are summarized based on replies obtained in response to questions or the like asked to the presentation destinations, in advance, are pieces of output information, for example. Machine learning such as a decision tree or multivariable analysis may also be used to construct the presentation information determination model.

Furthermore, the determining unit 120 may also determine the judgment support information to be presented to the presentation destination by also considering image data or video data that shows actual situation in the object region, in addition to the estimated disaster situation and the acquired presentation destination. The disaster situation is estimated by the disaster situation estimating unit 110, but how the disaster situation is understood may differ depending on the presentation destination. Therefore, the determining unit 120, as a result of determining the judgment support information to be presented to the presentation destination by considering image data or video data that shows the actual situation, can present more appropriate information. Upon determining the judgment support information to be presented to the presentation destination, the determining unit 120 outputs this information to the output processing unit 140.

The disaster related information acquiring unit 130 acquires disaster related information from a server or the like that is connected to the judgment support apparatus 100 via a network. The disaster related information acquiring unit 130 collects information that is sent by administrative agencies such as a national government and local public organizations and companies that provide infrastructure equipment, and collects SNS messages sent by residents, for example. The disaster related information acquiring unit 130 regularly acquires disaster related information, and outputs this information to the disaster situation estimating unit 110. The timing at which the disaster related information is acquired can be set as appropriate by a user.

The output processing unit 140 performs processing for causing the output apparatus 300 to present judgment support information. The output processing unit 140 performs processing for presenting judgment support information in the output apparatus 300 in a preset presentation format or in a presentation format that is designated by a user through the input apparatus 200. For example, the output processing unit 140 may present judgment support information along with disaster related information or an estimated disaster situation. When the estimated disaster situation is presented on map data, the output processing unit 140 may present the judgment support information on the map data using a pop-up window or the like, or may present in a display window that is separate from the map. The output processing unit 140 outputs the information subjected to the output processing to the output apparatus 300.

The storage unit 150 stores various types of information that are needed in the processing performed by the judgment support apparatus 100. The storage unit 150 stores the presentation information table, for example. Also, the storage unit 150 stores information such as presentation formats of judgment support information and other information to be presented to users. A configuration may be adopted in which these pieces of information can be updated by a user at any timing through the input apparatus 200. The information stored in the storage unit 150 can be referred to by the functional units that constitute the judgment support apparatus 100.

The judgment support apparatus 100 described above is connected to the input apparatus 200 and the output apparatus 300. The input apparatus 200 serves as an interface that is operated by a user to input information, such as a mouse, a keyboard, a touch panel, s button, a switch, and a lever, for example. The output apparatus 300 is a device for presenting information to users, and may be a display device such as a liquid crystal display device, a plasma display device, or an EL display device, for example. Alternatively, the output apparatus 300 may also be a printer, a mobile communication terminal, a facsimile, or the like, and may also has a sound output function such as a speaker for outputting information by sound.

[3. Judgment Support Method]

[3-1. Processing Details]

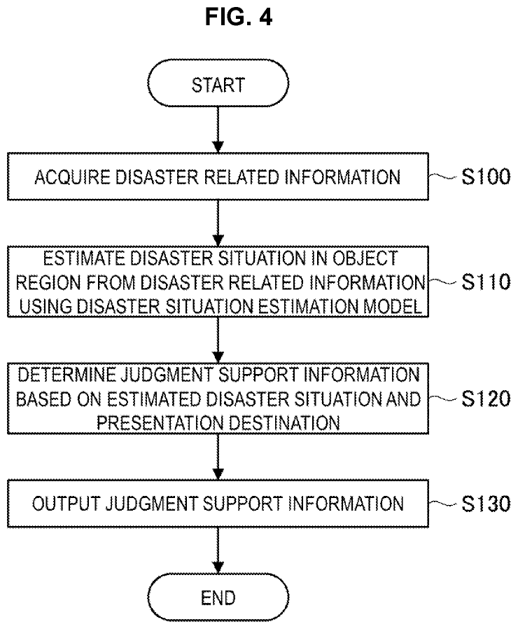

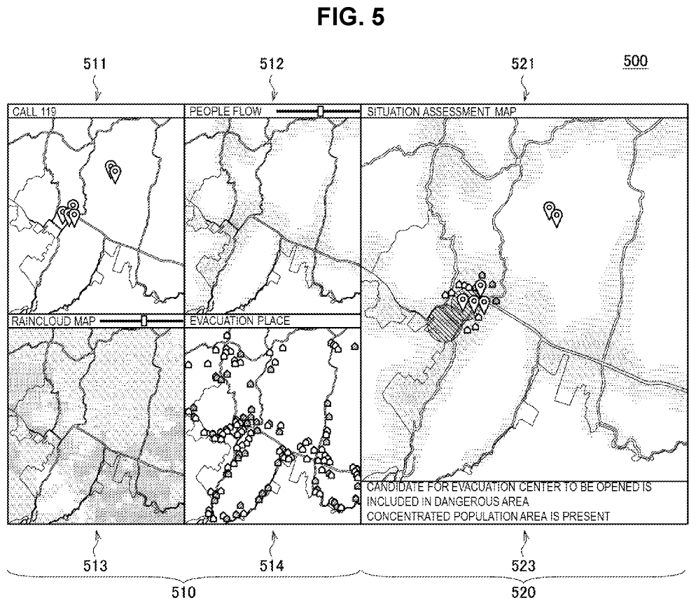

The judgment support method according to the present example embodiment will be described based on FIGS. 4 and 5. FIG. 4 is a flowchart illustrating an example of the judgment support method according to the present example embodiment. FIG. 5 is one exemplary presentation of the judgment support information. The judgment support method according to the present example embodiment is implemented by operating the judgment support apparatus 100.

(S100: Acquire Disaster Related Information)

In the judgment support method according to the present example embodiment, as shown in FIG. 4, the disaster related information acquiring unit 130 acquires disaster related information (S100). The disaster related information acquiring unit 130 acquires disaster related information from a server or the like that is connected to the judgment support apparatus 100 via a network, at a predetermined timing. The disaster related information acquiring unit 130 outputs the acquired disaster related information to the disaster situation estimating unit 110. The acquired disaster related information may also be stored in the storage unit 150.

(S110: Estimate Disaster Situation)

Next, the disaster situation estimating unit 110 estimates the disaster situation in an object region from the disaster related information using a disaster situation estimation model (S110). Upon acquiring disaster related information in step S100, the disaster situation estimating unit 110 analyzes the disaster related information using the disaster situation estimation model, and estimates the disaster situation in the object region. The disaster situation estimating unit 110 outputs the result of estimating the disaster situation in the object region to the determining unit 120.

(S120: Determine Judgment Support Information)

Upon the disaster situation being estimated in step S110, the judgment support information to be presented to the presentation destination is determined based on the disaster situation estimated in step S110 and the presentation destination of the judgment support information (S120).

First, the determining unit 120 acquires a user ID of the user that uses the judgment support apparatus 100, and acquires the presentation destination of the judgment support information. Next, the determining unit 120 determines the judgment support information to be presented based on the acquired presentation destination and the disaster situation estimated in step S110. Specifically, the configuration may be such that the determining unit 120 refers to the presentation information table stored in the storage unit 150, and presents judgment support information that is associated with the presentation destination (e.g., user ID). Alternatively, the determining unit 120 may determine the judgment support information to be presented using the presentation information determination model. Furthermore, the determining unit 120 may also determine the judgment support information to be presented to the presentation destination by also considering image data or video data that shows actual situation in the object region, in addition to the estimated disaster situation and the acquired presentation destination. Upon determining the judgment support information to be presented to the presentation destination, the determining unit 120 output this information to the output processing unit 140.

(S130: Present Information)

Then, the output processing unit 140 causes the output apparatus 300 to present the judgment support information determined in step S130 (S130). The output processing unit 140 performs processing for presenting judgment support information in the output apparatus 300 in a preset presentation format or in a presentation format that is designated by the user through the input apparatus 200. The output processing unit 140 outputs the information subjected to the output processing to the output apparatus 300. The output apparatus 300 outputs and presents the information input from the output processing unit 140.

Here, one exemplary presentation of information 500 to be presented in the output apparatus 300 is shown in FIG. 5. In the information 500 shown in FIG. 5, disaster related information 510 and judgment support information 520 are arranged side by side.

The disaster related information 510 is one or more pieces of information that have been used to estimate the judgment support information 520. In the example shown in FIG. 5, information 511 related to emergency reports to fire services, people flow information 512, raincloud information 513, and evacuation place information 514 are presented.

The judgment support information 520 is information for supporting judgment to be made by a user regarding the disaster response, which has been obtained based on the disaster related information including the presented disaster related information 511 to 514. The contents of the judgment support information 520 to be presented differ according to the presentation destination to which this information 500 is to be presented, even if the judgment support information 520 is based on the same disaster related information 510. Serving as the judgment support information 520, a situation assessment map 521 showing the disaster situation estimated in step S110 and supplementary information 523 regarding the disaster situation are presented in FIG. 5.

In the situation assessment map 521, areas in which damage is estimated to be large based on the disaster related information, areas in which it is highly possible that a disaster will occur later, and the like are displayed on the map data, for example. The supplementary information 523 is detailed information of which the user is to be notified, regarding the disaster situation presented on the situation assessment map 521. For example, a configuration is possible in which, upon the user designating a predetermined position on the situation assessment map 521 using the input apparatus 200, information regarding the designated position is presented in the supplementary information 523.

Note that, as a result of arranging the disaster related information 510 and the judgment support information 520 side by side, the user can easily comprehend the correspondence relationship between information regarding an event that is actually occurring (disaster related information 510) and information regarding the fact that information has been estimated therefrom (judgment support information 520). Also, the disaster related information 510 and judgment support information 520 to be presented may be presented using maps of the same scale, as shown in FIG. 5. Accordingly, the user can easily comprehend the correspondence relationship between the disaster related information 510 and the judgment support information 520. Note that the presentation method of the disaster related information and judgment support information, and the number of pieces of disaster related information to be presented are not limited to those in the example shown in FIG. 5.

[3-2. Presentation of Judgment Support Information According to Presentation Destination]

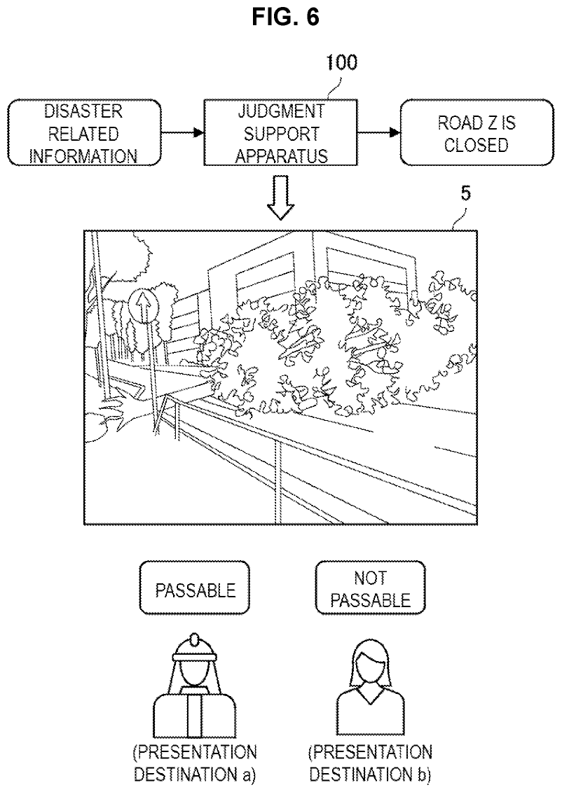

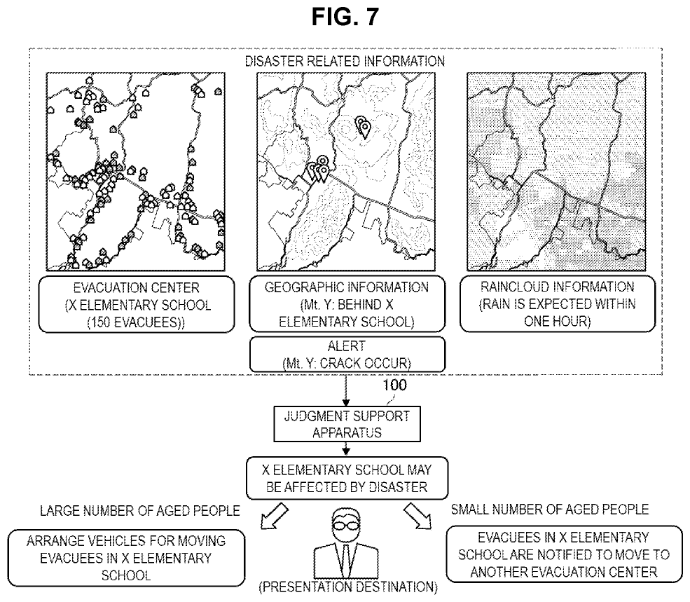

A specific example of the judgment support information to be presented according to the presentation destination will be described based on FIGS. 6 and 7.

(1) Case Where User Attributes of Presentation Destinations are Different

First, an exemplary presentation of the judgment support information when the user attributes of the presentation destinations are different will be described based on FIG. 6. Users whose user attributes are different, such as a local government, a firefighting organization, and ordinary citizens are envisioned as the presentation destinations of the judgment support information in this example, for example. As an example, a case is considered where a firefighting organization (presentation destination a) and an ordinary citizen (presentation destination b) are presentation destinations of the judgment support information.

In the example shown in FIG. 6, it is assumed that the disaster situation estimating unit 110 of the judgment support apparatus 100 has estimated that a road Z needs to be closed based on the disaster related information. Also, it is assumed that, regarding the road Z, an image 5 showing that passage of a road is not possible due to a fallen tree has been acquired, as image data showing actual situation.

Here, the determining unit 120 refers to the presentation information table, and upon determining that the road can be made passable by cutting the fallen tree when the presentation destination is a firefighting organization, presents a message that “road Z is passable” to the firefighting organization, for example. On the other hand, to an ordinary citizen, the determining unit 120 refers to the presentation information table, and upon determining that the road is not passable when a fallen tree is present, presents a message that “road Z is not passable” to the ordinary citizen, for example. In this way, the judgment support apparatus 100 can present appropriate judgment support information according to the presentation destination of the judgment support information based on image data showing the actual situation, even in the same disaster situation.

(2) Case Where Properties of Presentation Destinations are Different, Although User Attributes are the Same

Next, an exemplary presentation of the judgment support information when the properties of the presentation destinations are different, although the user attributes thereof are the same will be described based on FIG. 7. If a description is given taking local governments as an example, local governments that differ in local government properties such as a geological property and a social property, although the user attributes thereof are the same as a local government, are envisioned as the presentation destinations of the judgment support information in this example. Here, the geological property represents geographical features such as a mountain range, a coastal area, and an area along a river having a large-scale dam upstream, and can be specified by topographical information such as altitude, for example. Also, the social property means a population distribution (region having many aged people, underpopulated area, and the like), classification of regions such as an urban area and a country area, main means of traffic, and the like.

Even regarding damage in wind and flood damage, for example, various risks are envisioned from one event based on the geographic property or the social property of a local government. As specific disaster risks, traffic paralysis in an urban area, isolation of residents in an underpopulated area, river flooding due to presence or absence of a large-scale dam upstream, and the like are conceivable.

Therefore, the judgment support apparatus 100 according to the present example embodiment parameterizes the local government properties according to the degree of influence on the disaster risk, and takes the parameters into consideration when the determining unit 120 determines the judgment support information to be presented to the presentation destination. That is, the parameterized local government properties are used as input information when constructing the presentation information determination model. Accordingly, a presentation information determination model can be obtained that outputs judgment support information in which the local government properties are considered. The parameterization of the local government properties may be performed by representing the indices of the local government properties using values from 0 to 1. For example, the parameter of a region having many aged people can be represented by the ratio of population aged 75 years and older to the total population.

Note that the parameterized local government properties may be used as input information when constructing the presentation information determination model, as described above, or may also be used as weight information regarding outputs of the presentation information determination model.

In the example shown in FIG. 7, it is assumed that the disaster situation estimating unit 110 of the judgment support apparatus 100 estimates that “X elementary school (evacuation center) may be affected by disaster” based on disaster related information such as “150 evacuees in X elementary school”, “mountain Y is present behind X elementary school”, “cracks formed in mountain Y”, and “rain is expected within one hour”, for example. Upon receiving the judgment support information regarding the designated disaster situation, the determining unit 120 determines judgment support information to be presented to a local government that is the presentation destination using the presentation information determination model.

Here, if the local government that is the presentation destination of the judgment support information is a region in which the ratio of aged people is high, for example, it is considered that it is difficult for the evacuees in X elementary school to evacuate by themselves. In this case, the determining unit 120 may present information indicating that vehicles for moving the evacuees in X elementary school need to be arranged, as the judgment support information, for example. On the other hand, if the local government that is the presentation destination of the judgment support information is a region in which the ratio of aged people is low, for example, it is considered that it is possible for the evacuees in X elementary school to evacuate by themselves. In this case, the determining unit 120 may present information indicating that a notification is to be made to the evacuees in X elementary school indicating that they should move to another safe evacuation center, as the judgment support information, for example.

In this way, even in a case where the disaster situation is the same, and the users of the presentation destinations have the same user attribute, the judgment support apparatus 100 can present appropriate judgment support information according to the properties of the presentation destinations.

As described above, the judgment support apparatus 100 according to the present example embodiment and the judgment support method using this apparatus have been described. According to the present example embodiment, the judgment support apparatus 100 at least estimates the disaster situation in an object region from disaster related information using a disaster situation estimation model, and determines the judgment support information to be presented to the presentation destination based on at least the estimated disaster situation and the presentation destination of the judgment support information. Accordingly, the judgment support apparatus 100 can present appropriate judgment support information according to the presentation destination of the judgment support information. As a result, appropriate judgment support information can be presented to each of the users whose viewpoints regarding the same disaster situation differ. As a result, the users can perform disaster response appropriately and smoothly.

[4. Program]

The program according to the present example embodiment need only be a program for causing a computer to function as the functional units shown in FIG. 1 or 3. The judgment support apparatus 100 and the judgment support method according to the present example embodiment can be realized by installing this program in the computer and executing this program. In this case, a processor of the computer functions and performs processing as the disaster situation estimating unit 110 and the determining unit 120 of the judgment support apparatus 100, and furthermore as the disaster related information acquiring unit 130 and the output processing unit 140.

Also, in the present example embodiment, the storage unit 150 may be realized by storing a data file that configures these in a storage device included in the computer, such as a hard disk, or may also be realized by a storage device of another computer. Specific examples of the computer includes a smartphone and a tablet terminal device, in addition to an ordinary PC.

Furthermore, the program according to the present example embodiment may be executed by a computer system constructed by a plurality of computers. In this case, for example, each computer may function as one of the disaster situation estimating unit 110, the determining unit 120, the disaster related information acquiring unit 130, and the output processing unit 140.

[4. Physical Configuration]

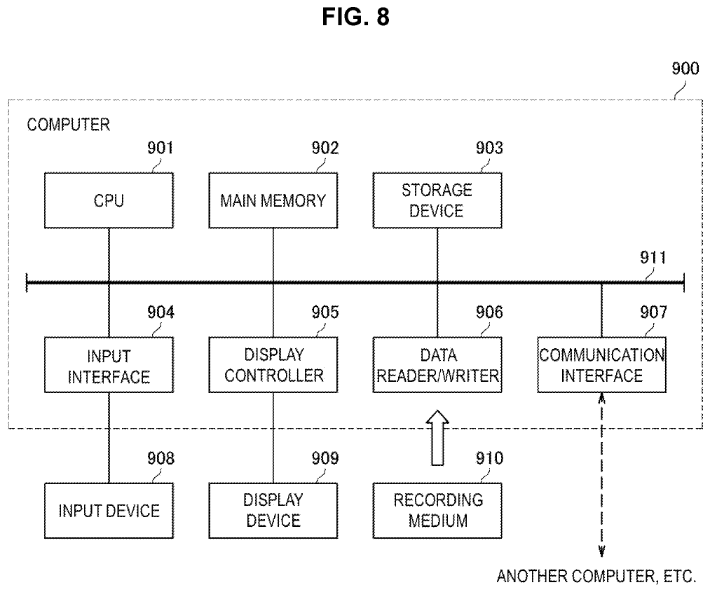

Using FIG. 8, a description is now given of a computer that realizes the judgment support apparatus 100 by executing the program according to the present example embodiment. FIG. 8 is a block diagram illustrating one example of the computer 900 that realizes the judgment support apparatus 100 according to the example embodiment.

As illustrated in FIG. 8, a computer 900 includes a CPU (Central Processing Unit) 901, a main memory 902, a storage device 903, an input interface 904, a display controller 905, a data reader/writer 906, and a communication interface 907. These components are connected in such a manner that they can perform data communication with one another via a bus 911.

Also, a computer 900 may include a GPU (Graphics Processing Unit) or an FPGA (Field-Programmable Gate Array) in addition to the CPU 901 or in place of the CPU 901. In this case, the GPU or the FPGA can execute the program according to the present example embodiment.

The CPU 901 carries out various types of computation by deploying the program that constituted by a group of codes according to the present example embodiment stored in the storage device 903 to the main memory 902, and executing the deployed each codes in a predetermined order. The main memory 902 is typically a volatile storage device, such as a DRAM (Dynamic Random Access Memory).

Also, the program according to the present example embodiment is provided in a state where it is stored in a computer readable recording medium 910. Note that the program according to the present example embodiment may also be distributed over the Internet connected via the communication interface 907.

Furthermore, specific examples of the storage device 903 include a hard disk drive, and also a semiconductor storage device, such as a flash memory. The input interface 904 mediates data transmission between the CPU 901 and an input device 908, such as a keyboard and a mouse. The display controller 905 is connected to a display device 909, and controls displays on the display device 909.

The data reader/writer 906 mediates data transmission between the CPU 901 and the recording medium 910, and executes readout of the program from the recording medium 910, as well as writing of the result of processing in the computer 900 to the recording medium 910. The communication interface 907 mediates data transmission between the CPU 901 and another computer.

Also, specific examples of the recording medium 910 include: a general-purpose semiconductor storage device, such as CF (Compact Flash®) and SD (Secure Digital); a magnetic recording medium, such as Flexible Disk; and an optical recording medium, such as CD-ROM (Compact Disk Read Only Memory).

Note that the judgment support apparatus 100 according to the present example embodiment can also be realized by using items of hardware corresponding to respective components, rather than by using the computer with the program installed therein. Furthermore, a part of the judgment support apparatus 100 may be realized by the program, and the remaining part of the judgment support apparatus 100 may be realized by hardware.

A part or all of the aforementioned example embodiment can be described as, but is not limited to, the following (Supplementary Note 1) to (Supplementary Note 24).

(Supplementary Note 1)

A judgment support apparatus including:

a disaster situation estimating unit configured to estimate a disaster situation in an object region from disaster related information using a disaster situation estimation model; and

a determining unit configured to determine, based on at least an estimated disaster situation and a presentation destination of judgment support information for supporting judgment with respect to the disaster situation, the judgment support information to be presented to the presentation destination.

(Supplementary Note 2)

The judgment support apparatus according to Supplementary Note 1, in which the determining unit determines the judgment support information to be presented to the presentation destination, based on the estimated disaster situation and a user attribute of a user that is the presentation destination.

(Supplementary Note 3)

The judgment support apparatus according to Supplementary Note 2, in which the determining unit determines the judgment support information while further considering image data or video data regarding the object region.

(Supplementary Note 4)

The judgment support apparatus according to any one of Supplementary Notes 1 to 3, in which the determining unit determines the judgment support information to be presented to the presentation destination, based on an estimated disaster situation and a local government property of a local government that is the presentation destination.

(Supplementary Note 5)

The judgment support apparatus according to Supplementary Note 4, in which the local government property is parameterized according to the degree of influence on a disaster risk.

(Supplementary Note 6)

The judgment support apparatus according to any one of Supplementary Notes 1 to 5, further includes an output processing unit configured to output the judgment support information to an output device.

(Supplementary Note 7)

The judgment support apparatus according to Supplementary Note 6, in which the output processing unit displays the judgment support information on map data.

(Supplementary Note 8)

The judgment support apparatus according to any one of Supplementary Notes 1 to 7, in which the disaster related information at least includes people flow information.

(Supplementary Note 9)

A judgment support method including:

estimating a disaster situation in an object region from disaster related information using a disaster situation estimation model; and

determining, based on at least an estimated disaster situation and a presentation destination of judgment support information for supporting judgment with respect to the disaster situation, the judgment support information to be presented to the presentation destination.

(Supplementary Note 10)

The judgment support method according to Supplementary Note 9, in which determining the judgment support information to be presented to the presentation destination, based on the estimated disaster situation and a user attribute of a user that is the presentation destination.

(Supplementary Note 11)

The judgment support method according to Supplementary Note 10, in which determining the judgment support information while further considering image data or video data regarding the object region.

(Supplementary Note 12)

The judgment support method according to any one of Supplementary Notes 9 to 11, in which determining the judgment support information to be presented to the presentation destination, based on an estimated disaster situation and a local government property of a local government that is the presentation destination.

(Supplementary Note 13)

The judgment support method according to Supplementary Note 12, in which the local government property is parameterized according to the degree of influence on a disaster risk.

(Supplementary Note 14)

The judgment support method according to any one of Supplementary Notes 9 to 13, including: outputting the judgment support information to an output device.

(Supplementary Note 15)

The judgment support method according to Supplementary Note 14, including: displaying the judgment support information on map data.

(Supplementary Note 16)

The judgment support method according to any one of Supplementary Notes 9 to 15, in which the disaster related information at least includes people flow information.

(Supplementary Note 17)

A computer readable recording medium that includes a program recorded thereon, the program causing a computer to function as a judgment support apparatus including:

a disaster situation estimating unit configured to estimate a disaster situation in an object region from disaster related information using a disaster situation estimation model; and

a determining unit configured to determine, based on at least an estimated disaster situation and a presentation destination of judgment support information for supporting judgment with respect to the disaster situation, the judgment support information to be presented to the presentation destination.

(Supplementary Note 18)

The computer readable recording medium according to Supplementary Note 17, that includes a program recorded thereon, the program causing a computer to function as a judgment support apparatus, in which the determining unit determines the judgment support information to be presented to the presentation destination, based on the estimated disaster situation and a user attribute of a user that is the presentation destination.

(Supplementary Note 19)

The computer readable recording medium according to Supplementary Note 18, that includes a program recorded thereon, the program causing a computer to function as a judgment support apparatus, in which the determining unit determines the judgment support information while further considering image data or video data regarding the object region.

(Supplementary Note 20)

The computer readable recording medium according to any one of Supplementary Notes 17 to 19, that includes a program recorded thereon, the program causing a computer to function as a judgment support apparatus, in which the determining unit determines the judgment support information to be presented to the presentation destination, based on an estimated disaster situation and a local government property of a local government that is the presentation destination.

(Supplementary Note 21)

The computer readable recording medium according to Supplementary Note 20, in which the local government property is parameterized according to the degree of influence on a disaster risk.

(Supplementary Note 22)

The computer readable recording medium according to any one of Supplementary Notes 17 to 21, that includes a program recorded thereon, the program causing a computer to function as a judgment support apparatus, further includes an output processing unit configured to output the judgment support information to an output device.

(Supplementary Note 23)

The computer readable recording medium according to Supplementary Note 22, that includes a program recorded thereon, the program causing a computer to function as a judgment support apparatus, in which the output processing unit displays the judgment support information on map data.

(Supplementary Note 24)

The computer readable recording medium according to any one of Supplementary Notes 17 to 23, in which the disaster related information at least includes people flow information.

Although the invention of the present application has been described above with reference to an example embodiment, the invention is not limited to the example embodiment described above. Various modifications apparent to those skilled in the art can be made to the configurations and details of the invention within the scope of the invention.

### INDUSTRIAL APPLICABILITY

As described above, according to the invention, it can be supported a response when a disaster occurs. The invention is useful in a supporting disaster response field.

### LIST OF REFERENCE SIGNS

100 Judgment support apparatus

110 Disaster situation estimating unit

120 Determining unit

130 Disaster related information acquiring unit

140 Output processing unit

150 Storage unit

200 Input apparatus

300 Output apparatus

900 Computer

901 CPU

902 Main memory

903 Storage device

904 Input interface

905 Display controller

906 Data reader/writer

907 Communication interface

908 Input device

909 Display device

910 Recording medium

911 Bus

What is claimed is:

1. A judgment support apparatus comprising:
a disaster situation estimating unit configured to estimate a disaster situation in an object region from disaster related information using a disaster situation estimation model; and
a determining unit configured to determine, based on at least an estimated disaster situation and a presentation destination of judgment support information for supporting judgment with respect to the disaster situation, the judgment support information to be presented to the presentation destination.

2. The judgment support apparatus according to claim 1, wherein the determining unit determines the judgment support information to be presented to the presentation destination, based on the estimated disaster situation and a user attribute of a user that is the presentation destination.

3. The judgment support apparatus according to claim 2, wherein the determining unit determines the judgment support information while further considering image data or video data regarding the object region.

4. The judgment support apparatus according to claim 1, wherein the determining unit determines the judgment support information to be presented to the presentation destination, based on an estimated disaster situation and a local government property of a local government that is the presentation destination.

5. The judgment support apparatus according to claim 4, wherein the local government property is parameterized according to the degree of influence on a disaster risk.

6. The judgment support apparatus according to claim 1, further comprising an output processing unit configured to output the judgment support information to an output device.

7. The judgment support apparatus according to claim 6, wherein the output processing unit displays the judgment support information on map data.

8. The judgment support apparatus according to claim 1 wherein the disaster related information at least includes people flow information.

9. A judgment support method comprising:
estimating a disaster situation in an object region from disaster related information using a disaster situation estimation model; and
determining, based on at least an estimated disaster situation and a presentation destination of judgment support information for supporting judgment with respect to the disaster situation, the judgment support information to be presented to the presentation destination.

10. A non-transitory computer readable recording medium that includes a program recorded thereon, the program causing a computer to function as a judgment support apparatus including:
a disaster situation estimating unit configured to estimate a disaster situation in an object region from disaster related information using a disaster situation estimation model; and
a determining unit configured to determine, based on at least an estimated disaster situation and a presentation destination of judgment support information for supporting judgment with respect to the disaster situation, the judgment support information to be presented to the presentation destination.
